(19) United States
(12) Patent Application Publication
(10) Pub. No.: US 2024/0375206 A1
(43) Pub. Date: Nov. 14, 2024

(54) METHOD OF RESISTANCE SPOT WELDING OF ELECTRICALLY CONDUCTIVE WORKPIECES FOR ELECTRIC VEHICLES

(71) Applicant: GM Global Technology Operations LLC, Detroit, MI (US)

(72) Inventors: Huaxin Li, Rochester Hills, MI (US); Pankaj Kumar Jha, Troy, MI (US); Lala Ram Patel, Bangalore (IN); Yi Liu, Troy, MI (US)

(21) Appl. No.: 18/314,315

(22) Filed: May 9, 2023

(51) Int. Cl. B23K 11/11

(52) U.S. Cl. CPC B23K 11/115

(57) ABSTRACT

A method of joining overlapping copper workpieces. The method includes overlapping a first copper workpiece with a second copper workpiece such that a plurality of projections on a second faying surface of the second copper workpiece are in contact with the first faying surface of the first copper work piece at a joining location where a metallurgical joint is ultimately established. The method further includes applying a compression force against a first exterior surface of the first copper workpiece and a second exterior surface of the second copper workpiece to urge the faying surfaces together, and passing an electric current at the joining location through the first and the second copper workpieces. The electric current flows through the plurality of projections to generate sufficient heat to effectuate the collapsing of the plurality of projections to bring the first second faying surfaces into contact to establish the metallurgical joint.

### INTRODUCTION

The present disclosure relates to welding of electrically conductive workpieces, more specifically to a method of resistance spot welding of electrically conductive copper workpieces for vehicles.

Electric vehicles (EV) and hybrid-electric vehicles (HEV) rely on higher voltage electric systems than those of vehicles having internal combustion engines for propulsion and associated vehicle operations. These higher voltage electrical systems include one or more rechargeable batteries electrically connected to various vehicle electrical devices, such as electric motors and electrical charging devices. Copper and aluminum are extensively used in wiring harnesses and electrical connectors for the conductance of electricity from the rechargeable batteries to the electrical devices throughout the vehicle.

Electrical connectors used in the EV and HEV vehicles include electrical connectors that include a bundle of wires crimped to a tab formed of copper or aluminum. The tab is configured to be receivable into a receptacle of a corresponding electrical connector or joined to a tap of a corresponding electrical connector with mechanical fasteners such as bolts and nuts. Thus, while mechanical fasteners achieve their intended purpose for joining electrically conductive tabs, there is a need for a more robust method for joining electrically conductive tabs, especially electrically conductive tabs formed of highly conductive metals such as copper.

### SUMMARY

According to several aspects, a method of resistance spot welding is disclosed. The method includes providing a first metal workpiece having a first faying surface and a first exterior surface opposite the first faying surface and providing a second metal workpiece having a second faying surface and a second exterior surface opposite the second faying surface. One of the first faying surface and the second faying surface includes a plurality of projections. The method further includes assembling the first metal workpiece in overlapping arrangement with the second metal workpiece such that the plurality of projections are in contact with the other of the first faying surface and the second faying surface, applying a compression force against the first metal workpiece and the second metal workpiece to urge the first faying surface toward the second faying surface, and passing an electrical current through the first metal workpiece and the second metal workpiece. The electrical current is sufficient to generate and concentrate heat within the plurality of projections to collapse the plurality of projections to establish a metallurgical joint to join the first metal workpiece to the second metal workpiece.

In an additional aspect of the present disclosure, the compression force is applied by a pair of spot welding electrodes including a first electrode having a first electrode face in contact with the first exterior surface of the first metal workpiece and a second electrode having a second electrode face in contact with the second exterior surface of the second metal workpiece. At least one of the first electrode face and the second electrode face includes a sufficient surface area in contact with the first exterior surface and the second exterior surface, respectively, to overlap an entirely of the plurality of projections.

In another aspect of the present disclosure, the first exterior surface is a planar first exterior surface and the second exterior surface is a planar second exterior surface. The first electrode face is a planar first electrode face and operable to apply a first force against the planar first exterior surface, and the second electrode face is a planar second electrode face and operable to apply a second force against the planar second exterior surface.

In another aspect of the present disclosure, each individual projection includes a surface contact area (SCA). At least one of the first electrode face and the second electrode face includes an electrode surface area (ESA) about 1.5 to 5.0 times larger than a total of the surface contact areas (SCA_{Total}) of the plurality of projections.

In another aspect of the present disclosure, an individual projection includes a width of about 0.5 to 5.0 mm, a height of greater than 0.5 mm, and a length of 5 mm to 20 mm.

In another aspect of the present disclosure, the plurality of projections include at least one of a semi-sphere, a flat ring, a plurality of flat concentric rings, a raised rectangle, and a raised polygon having a trapezoid cross section.

In another aspect of the present disclosure, the first metal workpiece and the second metal workpiece are copper workpieces.

In another aspect of the present disclosure, one of the first metal workpiece and the second metal workpiece is a copper workpiece and the other of the first metal workpiece and the second metal workpiece is an aluminum workpiece.

In another aspect of the present disclosure, the first metal workpiece and the second metal workpiece are electrically conductive tabs for an electric vehicle.

According to several aspects, a method of joining overlapping copper workpieces is disclosed. The method includes, providing a first copper workpiece having a first faying surface and a first exterior surface opposite the first faying surface; providing a second copper workpiece having a second faying surface defining a plurality of projections and a planar second exterior surface opposite the plurality of projections; overlapping the first copper workpiece and the second copper workpiece such that the plurality of projections of the second faying surface are in contact with the first faying surface at a joining location where a metallurgical joint is ultimately established; applying a compression force against the first exterior surface and the second exterior surface to urge the first faying surface and the second faying surface together; and passing an electric current at the joining location through the first copper workpiece and the second copper workpiece, such that the electric current flows through the plurality of projections to generate sufficient heat to effectuate a collapsing of the plurality of projections to bring the first faying surface and the second faying surface into a broader interfacial contact to establish the metallurgical joint.

In an additional aspect of the present disclosure, the compression force is applied by a pair of spot welding electrodes includes a first spot welding electrode and a second spot welding electrode having a planar second electrode face. The planar second electrode face is compressed against the planar second exterior surface of the second copper workpiece.

In another aspect of the present disclosure, the planar second electrode face includes a second electrode face surface area (ESA) sufficiently large to overlap an entirety of the plurality of projections at the joining location. The plurality of projections include a total surface contact area (SCA_{Total}). The ratio of the second electrode face surface area to total surface contact area (ESA:SCA_{Total}) is 1.5 to 5.0.

In another aspect of the present disclosure, the first faying surface of the first copper workpiece defines a plurality of first projections and the first exterior surface opposite the plurality of first projections is a planar first exterior surface. The first spot welding electrode includes a planar first electrode face. The step of applying the compression force includes compressing the planar first electrode face against the planar first exterior surface of the first copper workpiece.

In another aspect of the present disclosure, at least one of the plurality of projections includes a height of at least 0.55 mm, a base width of 0.5 mm to 5.00 mm, and a length of 5 mm to 20 mm.

According to several aspect, a method of resistance spot welding overlapping copper workpieces is disclosed. The method includes providing a first copper workpiece having a first faying surface defining a plurality of first projections and a planar first exterior surface opposite the plurality of first projections; providing a second copper workpiece having a second faying surface defining a plurality of second projections and a planar second exterior surface opposite the plurality of second projections; overlapping the first copper workpiece and the second copper workpiece such that the plurality of first projections of the first faying surface confronts the second faying surface and the plurality of second projections of the second faying surface confronts the first faying surface; applying a first force against the planar first exterior surface by a planar first electrode face and applying a second force against the planar second exterior surface by a planar second electrode face, thereby urging the first faying surface and the second faying surface together; and passing an electric current through the first copper workpiece and the second copper workpieces, such that the electric current flows through the plurality of first and second projections to generate sufficient heat to effectuate a collapsing of the plurality of first and second projections to bring the first faying surface and the second faying surface into a broader interfacial contact to establish a metallurgical joint.

In another aspect of the present disclosure, the plurality of first projections includes a total first projection surface contact area. The first electrode face includes a first electrode surface area 0.5 to 1.5 times greater than the total first projection surface contact area.

In another aspect of the present disclosure, an individual projection includes a trapezoidal cross-sectional area having a height of greater than 0.55 mm, a base width of 0.5 mm to 5.00 mm, and a length of 5 mm to 20 mm.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an illustration of a plan view of an electric vehicle, according to an exemplary embodiment;

FIG. 2 is an illustration of a plan view of an electrical connector having resistance spot welded metal workpieces, according to an exemplary embodiment;

FIG. 3 is an illustration of a cross-sectional side view of a stack-up assembly including a first metal workpiece overlapping a second metal workpiece having a plurality of raised projections, according to an exemplary embodiment;

FIG. 4 is an illustration of a cross-sectional side view of the stack assembly including a first metal workpiece having a plurality of raised projections overlapping a second metal workpiece having a plurality of raised projections, according to an exemplary embodiment;

FIG. 5 is an illustration of a cross-sectional side view of the first metal workpiece and the second metal workpiece of FIG. 4 joined by a resistance spot weld, according to an exemplary embodiment;

FIG. 6 is an illustration of a plan view of the second metal workpiece having a plurality of raised projections and an electrode face behind the second work piece;

FIG. 6A is an illustration of a cross-section of an embodiment of a raised projection along line 6-6 of FIG. 6;

FIG. 6B is an illustration of a cross-section of an alternative embodiment of the raised projection of FIG. 6A;

FIG. 7A-F are illustrations of plan views of alternative embodiments of the plurality of raised projections;

FIG. 8 a schematic illustration of a resistance spot welding apparatus, according to an exemplary embodiment;

FIG. 9 is a block diagram of a method of resistance spot welding metal workpieces, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

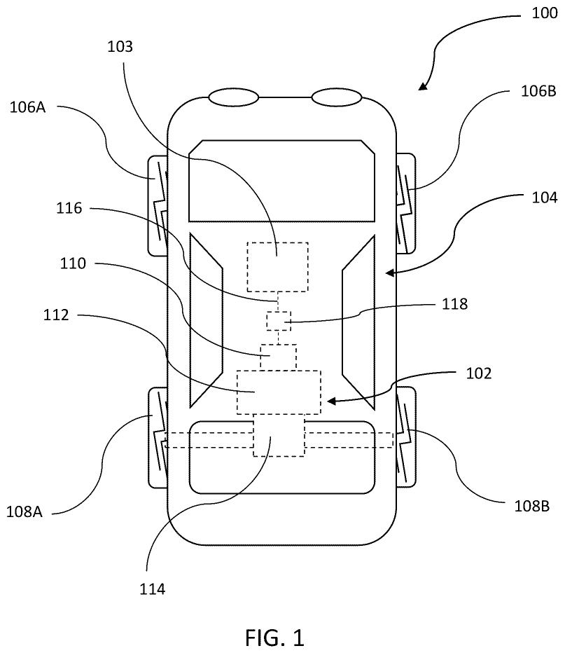

FIG. 1 is an illustration of an electric vehicle 100 having an Electric Drive Unit (EDU) 102 electrically connected to a rechargeable battery 103. The vehicle 100 generally includes a body 104 having front wheels 106A, 106B and rear wheels 108A, 108B. The front wheels 106A, 106B and the rear wheels 108A, 108B are each rotationally located near a respective corner of the body 104. The EDU 102 includes power electronics 110, an electric motor 112, and a gear box 114. The power electronics 110 are responsible for the conversion of DC voltage from the rechargeable battery 103 into a three-phase AC voltage for the overall operation and control of the electric motor 112. The electric motor 112 converts electrical energy into mechanical torque, which is transmitted through the gearbox 114 to one or more of the wheels 106A, 106B, 108A, 108B for propelling the vehicle 100. The rechargeable battery 103 is connected to various electrical components, such as the power electronics 110 and electric motor 112, via a wire harness 116 that relies on robust electrical connectors 118.

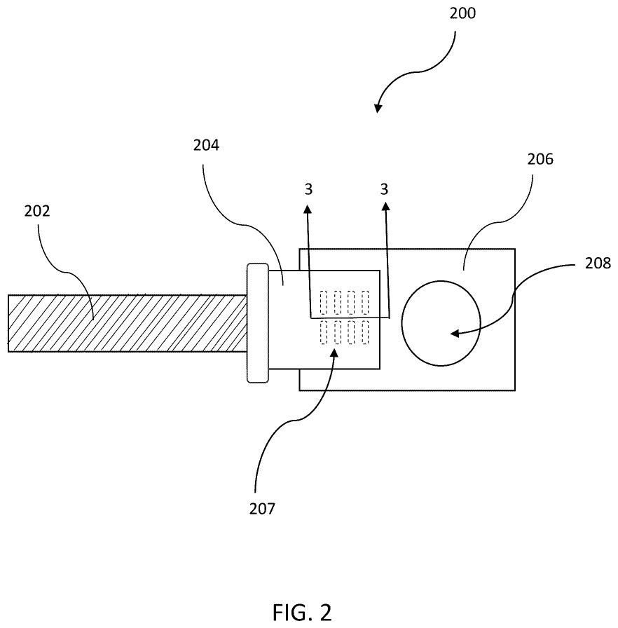

FIG. 2 is an illustration of an exemplary electrical connector 200 having resistance spot welded metal workpieces 204, 206. The metal workpieces 204, 206 may be formed of an electrically conductive metal such as copper and aluminum. In a non-limiting embodiment, the electrical connector 200 includes a bundle of wires 202 crimped to a first copper tab 204, also referred to as a first copper workpiece 204. The first copper workpiece 204 is overlapped and resistance spot welded to a second copper tab 206, also referred to as a second copper workpiece 206. At least one of the first copper workpiece 204 and second copper workpiece 206 includes a plurality of projections 207 that enable the resistance spot welding of the first copper workpiece 204 to the second copper workpiece 206.

In the non-limiting embodiment shown, the second copper workpiece 206 defines an aperture 208 that is configured to receive a battery post terminal or a mechanical fastener, such as a bolt, for connecting to another electrically conductive tab. It should be appreciated that the second copper workpiece 206 may also be crimped to a second bundle of wires (not shown), similar to the first copper workpiece 204, instead of having the aperture 208. It should be further appreciated that one of the first copper workpiece 204 and the second copper workpiece 206 may be replaced with an aluminum workpiece.

Resistance spot welding is a method of joining workpieces in which an electric current is passed through overlapping workpieces to resistively generate the heat needed to facilitate the joining of the workpieces across their faying interface. Resistance spot welding has been traditionally considered unworkable for joining together two or more copper workpieces. The electrical conductivity of pure annealed copper at 20° C. is 5.80×10⁷ S/m. The high electrical conductivity of copper makes it difficult to generate resistive heat within the copper workpieces along the current flow path that extends between spot welding electrodes.

Copper alloys typically used to construct spot welding electrodes are more electrically resistive than the copper workpieces, therefore sufficient current passing through overlapping copper workpieces to generate sufficient resistive heat may thermally damage the spot welding electrodes. A plurality of projections 207 are provided on at least one of the faying surfaces of the pair of adjacent overlapping first and second copper workpieces 204, 206. The plurality of projections 207 are utilized to overcome the problem with resistance spot welding of highly electrically conductive metal workpieces such as the first and second copper workpieces 204, 206. The plurality of projections 207 serve to concentrate the current flow through the first and second copper workpieces 204, 206 so that a targeted surge of heat is generated to form a metallurgical joint between the first and second copper workpieces 204, 206.

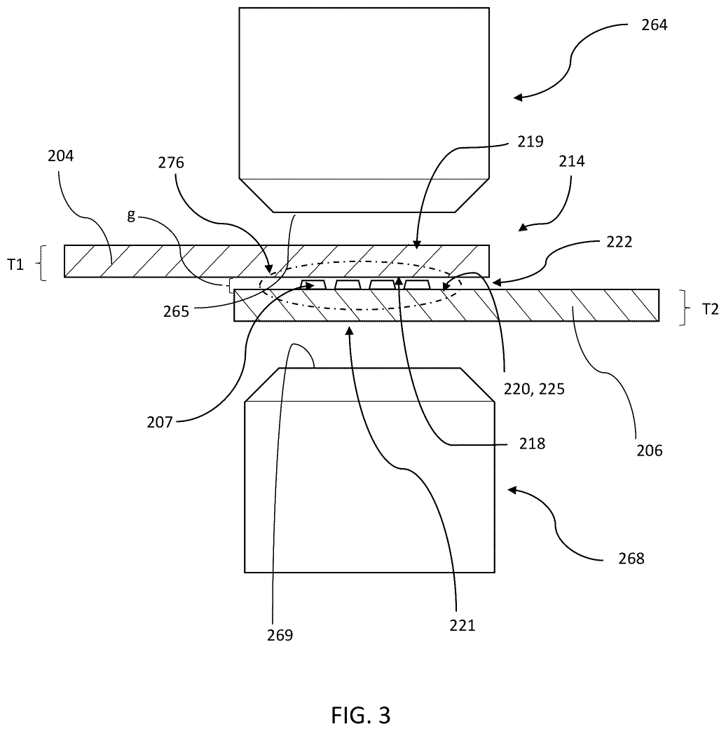

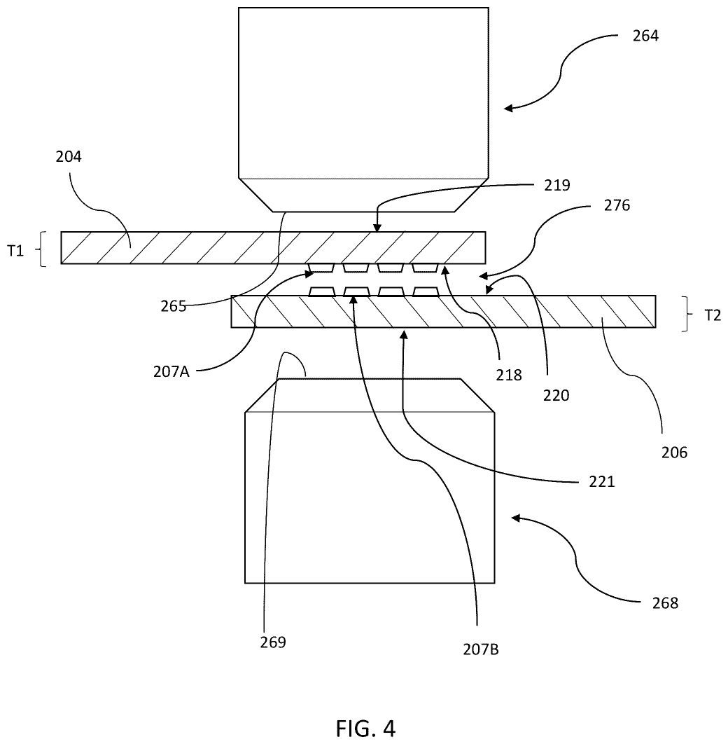

FIGS. 3 and 4 are illustrations of a cross-sectional view of a non-limiting embodiment of an arrangement of a first metal workpiece 204 overlapping a second metal workpiece 206. In the non-limiting embodiment, the first metal workpiece 204 is a first copper workpiece 204 and the second metal workpiece 206 is a second copper workpiece 206. The term “copper workpiece” as used herein is defined as a workpiece composed of unalloyed copper, also referred to as elemental copper, or a high-copper alloy. Unalloyed copper includes a minimum of 99.3 weight percent (wt %) copper, and preferably a minimum of 99.9 wt % copper, with acceptable impurities constituting the remainder. High-copper alloy that includes between 94 wt % and 99.2 wt % copper with one or more alloying elements constituting the remainder. The one or more alloying elements may be selected from Cr, Zr, Mg, Fe, P, Be, Co, S, Te, and Pb.

The first and second copper workpieces 204, 206 may both be composed of unalloyed copper, may both be composed of a high-copper alloy, or one of the copper workpieces 204, 206 may be composed of unalloyed copper while the other copper workpiece 204, 206 is composed of a high-copper alloy. Each of the first and second copper workpieces 204, 206 may have a corresponding thickness T1, T2 that ranges from 1.0 mm to 4.0 mm. The first copper workpiece 204 and the second copper workpiece 206 lie adjacent to one another and overlap at least to some extent.

The first copper workpiece 204 includes a first faying surface 218 and a first exterior surface 219 opposite the first faying surface 218. The second copper workpiece 206 includes a second faying surface 220 and a second exterior surface 221 opposite the second faying surface 220. Each of the first exterior surface 219 and the second exterior surface 221 is substantially planar or flat. The first faying surface 218 of the first copper workpiece 204 confronts the second faying surface 220 of the second copper workpiece 206 when arranged to be joined. In preparation for spot resistance welding, the first copper workpiece 204 and the second copper workpiece 206 are arranged in overlapping positions such that portions of the faying surfaces 218, 220 are separated from one another by a gap (g) prior to the passage of an electric current through the copper workpieces 204, 206. The overlapping and confronting faying surfaces 218, 220 establish a faying interface 222 between the first and second copper workpieces 204, 206 once joined by spot resistance welding.

At least one of the first copper workpiece 204 and the second copper workpiece 206 includes a plurality of projections 207 on the respective faying surfaces 218, 220. In the example shown in FIG. 3, the second copper workpiece 204 includes a plurality of projections 207 on the second faying surface 220. The plurality of projections 207 ascend beyond a surrounding base surface 225 of the second faying surface 220. The plurality of projections 207 are in contact with first faying surface 218 defining the gap (g) between the first and second faying surfaces 218, 220 outboard of the plurality of projections 207. In an alternative embodiment shown in FIG. 4, each of the first copper workpiece 204 and the second copper workpiece 206 includes a plurality of projections 207A, 207B, respectively. The plurality of projections 207A, 207B on each of the first copper workpiece 204 and the second copper workpiece 206 may be in direct alignment with each other or off-set from each other.

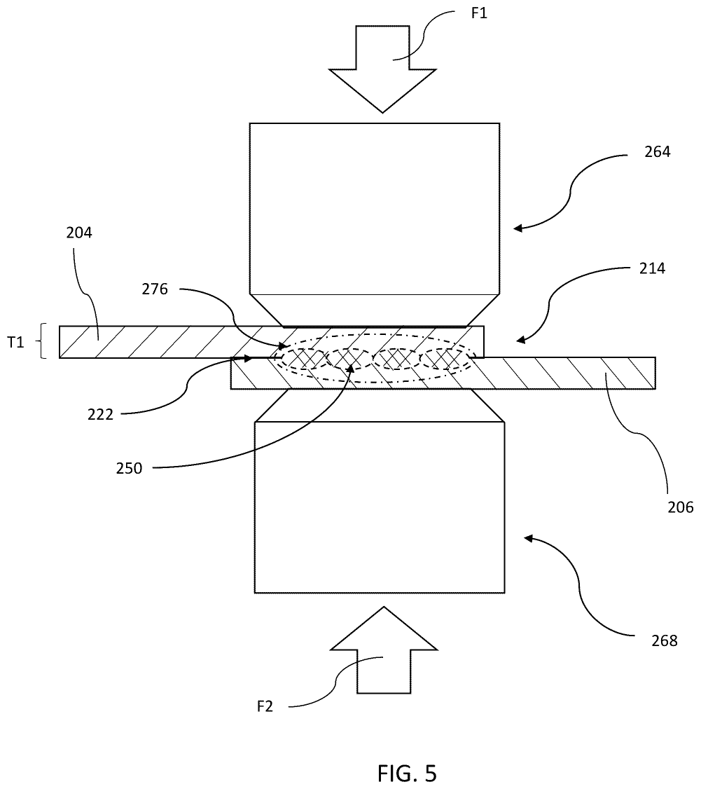

FIG. 5 is an illustration of a cross-sectional side view of the first copper workpiece 204 and the second copper workpiece 206 of FIG. 3 having a compressive force (F) applied against the first and second copper workpieces 204, 206. Referring to FIG. 3 and FIG. 5, the compressive force urges the plurality of projection 207 on the second faying surface 220 against the first faying surface 218 in a joining location 276 defined between the first and second spot welding electrodes 264, 268. An electric current is passed through the first and second copper workpieces 204, 206. The electric current initially flows through the plurality of projections 207 to generate and concentrate heat within the projections 207 as opposed to broadly within the first and second copper workpieces 204, 206.

The heat generated within the plurality of projections 207 eventually causes the plurality of projections 207 to soften and collapse under the applied compressive force. As a result, the first faying surface 218 and the second faying surface 220 are brought into broader interfacial contact along their faying interface 222, at which point the faying surfaces 218, 220 interact intermingling the soften or molten copper to form a metallurgical joint 250 in the form of a solid-state joint or a fusion joint. The passage of the electric current through the first and second copper workpieces 204, 206 is then terminated and the joined the first and second copper workpieces 204, 206 are cooled. Upon cooling, the metallurgical joint 250 is established between the first and second copper workpieces 204, 206 across their faying interface 222 at the joining location 276.

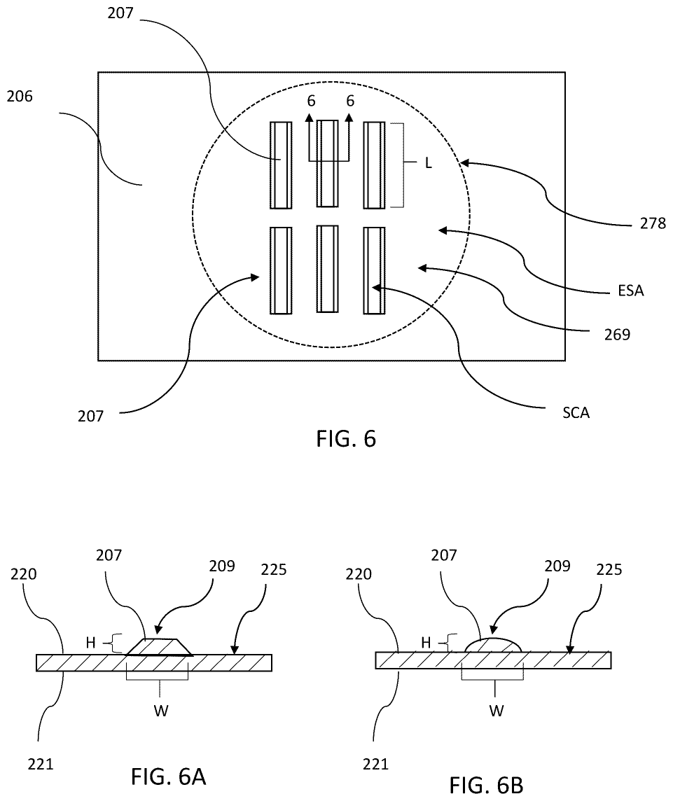

FIG. 6 is an illustration of a plan view of the second work piece 206 having a plurality of raised projections 207 and a second electrode face 269 of the second spot welding electrode 268 positioned behind the second work piece 206. The second electrode face 269 includes a periphery 278 defining an electrode surface area (ESA) of the second electrode face 269. Similarly, the first spot welding electrode 264 includes a first electrode face 265 having the same electrode surface area (ESA) as that of the second electrode face 269. In the embodiment shown, at least one of the projections 207 includes a trapezoid cross-section (best shown in FIG. 3 and FIG. 6A) and a rectangular contact area 209 (best shown in FIG. 6). Alternatively, the at least one of the projections 207 includes a dome cross-section as shown in FIG. 6B.

The plurality of projections 207 may be formed on the faying surface 220 by stamping, rolling with a die, etc. The electrode surface area (ESA) of the second electrode face 269 is sufficiently large to cover all of the plurality of projections 207 within the joining location 276. The first and second electrode faces 265, 269 are planar and configured to intimately contact the planar exterior surfaces 219, 221 of the workpieces 204, 206. Each of the projections 207 includes a surface contact area (SCA). A sum of the projections' surface contact areas SCA within the joining location 276 is referred to as the total projection contact area (SCA_{Total}). It is preferred that the ratio of the sum or total of the projection surface contact areas (SCA_{Total}) to the each of the electrode surface area (ESA) of the spot welding electrode faces 265, 269 is about 1.5 to 5.0.

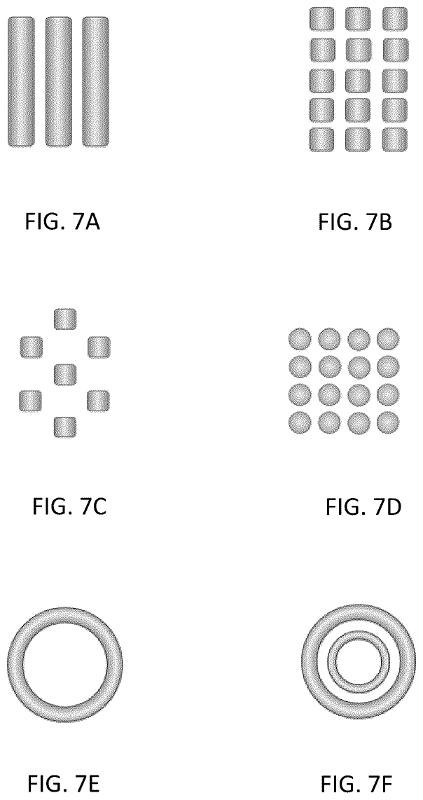

FIG. 7A-7F are illustrations of plan views of alternative embodiments of the shapes of the plurality of projections 207. The projections 207 may assume a multitude of shapes and contours. For example the projections 207 may be rectangular, pyramidal, conical, frustoconical, or square (FIGS. 7A-7C). In other embodiments, the projections 207 may be spherical (FIG. 7D), a flat ring or concentric flat rings (FIG. 7E-7F), or any other conceivable shapes and arrangements that ascend beyond the surrounding base surface 225 and are able to impose the gap (g) between first and second faying surfaces 218, 220 outboard of the projection 207.

In certain applications, referring to FIG. 6, FIG. 6A, and FIG. 6B the projections 207 may ascend beyond a surrounding base surface 225 of the second faying surface 220 to a height (H) of at least 0.5 mm and include a base width (W) of 0.5 mm to 5.0 mm along the faying surface 220, and a length (L) of 5 mm to 20 mm. The projections 207 may be formed in the first faying surface 218 and/or in the second faying surface 220 in accordance with numerous manufacturing methods. More specifically, and depending on several factors including the desired shape and contour, the projections 207 may be formed by mechanically deforming at least one of the faying surfaces 218, 220 of the first and second copper workpieces 204, 206, respectively. At least one of the first and second copper workpieces 204, 206 may be mechanically deformed by rolling a cylindrical tool with a knurled surface over the first and second faying surfaces 218, 220 to form the plurality of projections 207 in a single step as opposed to individually forming the several projections 207.

It should be appreciated that deforming at least one of the faying surfaces 218, 220 to form the plurality of projections 207 does not deform the respective exterior surfaces 219, 221. The exterior surfaces 219, 221 remain planar, also referred to as flat, to complement and receive the planar surfaces of the electrode faces 265, 269 of the respective spot welding electrodes 264, 268.

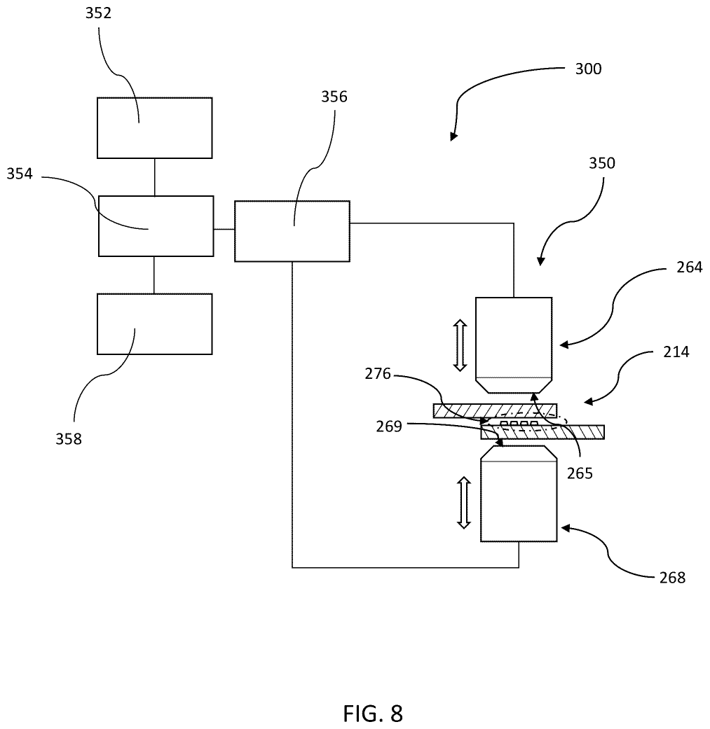

FIG. 8 is a schematic illustration of a resistance spot welding apparatus 300 having a weld gun 350, a power supply 352, a transformer 354, a rectifier 356, and a weld controller 358. The weld gun 350 includes a first spot welding electrode 264 and a second spot welding electrode 268 that are moveable towards and away from each other. The first spot welding electrode 264 includes a first electrode face 265 and the second spot welding electrode 268 includes a second electrode face 269. Each of the first electrode face 265 and the second electrode face 269 are planar to provide maximum area contact with the planar exterior surfaces 219, 221 of the first and second copper workpieces 204, 206, respectively. The first and second electrode faces 265, 269 may be formed of a copper alloy such as a zirconium copper alloy (ZrCu) that contains about 0.10 wt % to about 0.20 wt % zirconium and the balance copper. Other copper alloy compositions that possess suitable mechanical and electrically conductive properties may also be employed.

The power supply 352, the transformer 354, and the rectifier 356 electrically communicate with the first and second spot welding electrodes 264, 268 and supply the electric current that is exchanged between the spot welding electrodes 264, 268 during welding. The power supply 352 receives a three phase mains AC current and provides a high-voltage input AC current for delivery to the transformer 354. For example, the mains AC current may first be rectified and then inverted within the power supply 352 to produce a single-phase input AC current, usually a square wave AC current, of higher voltage. The input AC current is fed to the transformer 354, usually at 1000 Hz, which creates a magnetic flux that induces a lower-voltage, higher-amperage AC current. The AC current is then fed to the rectifier 356 where a collection of semiconductor diodes converts the supplied AC current into a low-ripple DC current suitable for delivery as the electric current through the first and second spot welding electrodes 264, 268.

The welding controller 358 controls the manner in which the electric current is delivered between the first and second spot welding electrodes 264, 268. The weld controller 358 may interface with the transformer 354 and allows a user to input a weld schedule that sets and manages the waveform of the electrical current being exchanged between the first and second spot welding electrodes 264, 268 over the course of a welding event. The weld controller 358 may be set to administer the electric current at a constant current level or it may be set to administer the electric current as a series of current pulses that may have constant or increasing peak current levels over time. The weld controller 358 is configured to implement predetermined weld schedules based on the composition of the first and second copper workpieces 204, 206, the thicknesses T1, T2 of the first and second copper workpieces 204, 206, the size and shape of the projection 207, the number of projections 207, and ratio of the projections total surface contact areas SCA_{Total} to the electrode surface area (ESA) of one of the first and second spot welding electrode 264, 268.

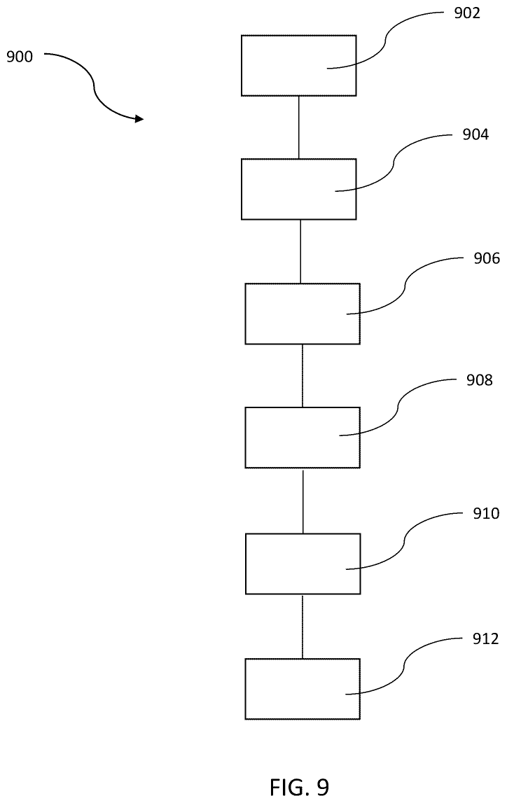

FIG. 9 shows a block diagram of the method of resistance spot welding the first and second copper workpieces 204, 206 (Method 900). The Method 900 is performed using the resistance spot welding apparatus of FIG. 8. The Method 900 starts in Block 902 by arranging the first and second copper workpieces 204, 206 to form a stack-up assembly 214. In one embodiment, referring to FIG. 3, the first and second copper workpieces 204, 206 are arranged such that the workpieces 204, 206 overlap and their respective faying surfaces 218, 220 confront each other such that the plurality of projections 207 on the second faying surface 220 make contact with the first faying surface 218 at a joining location 276 where a metallurgical joint is ultimately established. In another embodiment, referring to FIG. 4, the first and second copper workpieces 204, 206 are arranged such that the workpieces 204, 206 overlap and their respective faying surfaces 218, 220 confront each other such that the plurality of projections 207A ascending from the first faying surface 218 make contact with the opposing plurality of projections 207B ascending from the second faying surfaces 220 at a joining location 276 where a metallurgical joint is ultimately established. Yet in another embodiment, the first and second copper workpieces 204, 206 are arranged such that the workpieces 204, 206 overlap and their respective faying surfaces 218, 220 confront each other such that the plurality of projections 207A ascending from the first faying surface 218 are off-set from the opposing plurality of projections 207B ascending from the second faying surfaces 220 at the joining location 276 where a metallurgical joint is ultimately established.

Moving to Block 904 from Block 902, the stack-up assembly 214 is positioned relative to the weld gun 350 between the first and second spot welding electrodes 264, 268 in preparation for welding. The first and second spot welding electrodes 264, 268 are used to pass the electric current through the stack-up assembly 214 and across the faying interface 222 of the adjacent overlapping copper workpieces 204, 206 at the joining location 276. The first electrode face 265 of the first spot welding electrode 264 is pressed against the exposed planar first exterior surface 219 of the first copper workpiece 204 and the second electrode face 269 of the second spot welding electrode 268 is pressed against the exposed planar second exterior surface 221 of the second copper workpiece 206 in facial alignment with one another. The first electrode face 265 and second electrode face 269, as shown, cover the entirety of the joining location 276 of the stack-up assembly 214 including the entirety of the projections 207 within the joining location 276.

Moving to Block 906 from Block 904, the first and second spot welding electrodes 264, 268, respectively, applies a compressive force F against the workpieces 204, 206 at the joining location 276. The compression force includes the components of a first force (F1) and a second force (F2). The compressive force F urges the projections 207 at the first faying surface 218 against the second faying surface 220. The imposed compressive force F applied by the first and second spot welding electrodes 264, 268 preferably ranges from 250 lb_{f} (pounds force) to 1000 lbᵣ or, more narrowly, from 350 lb_{f} to 500 lb_{f}.

Moving to Block 908 from Block 906, an electric current is passed between the first and second spot welding electrodes 264, 268 and through the first and second copper workpieces 204, 206. This electric current is preferably a DC electric current supplied from the rectifier 356 associated with the weld gun 350. The electric current may be constant or pulsed over time according to a weld schedule that is controllable by the weld controller 358. In one particular embodiment, however, the electric current is passed at a constant current level ranging from 25 kA to 35 kA. The electric current may take from 5 milliseconds (ms) to 20 ms to reach its constant current level and may then be maintained nominally at that current level for a period of time ranging from 30 ms to 100 ms before dropping to 0 kA.

The electric current that is passed through the first and second copper workpieces 204, 206 initially flows through the projection 207 ascending from first faying surface 218 since that is the most direct electrical pathway between the copper workpieces 204, 206 within the joining location 276 at the time current flow is commenced. The initial flow of the electric current through the projections 207 increases the current density of the passing electric current across the faying interface 222 of the first and second copper workpieces 204, 206 by a factor of ten or more compared to the current density of the electric current at the interfaces of the weld faces 265, 269 and their respective exterior surfaces 219, 221 of the first and second copper workpieces 204, 206. The increased current density attained in the projections 207 generates and concentrates heat within the projections 207 so long as the projections 207 are structurally intact. This concentrated heat surge softens and melts the projection 207 as well as the immediately surrounding regions of the first and second faying surfaces 218, 220.

During the passage of the electric current through the first and second copper workpieces 204, 206, and as a consequence of the locally concentrated heat generated within the projections 207 at least initially, the projections 207 collapse and the first and second faying surfaces 218, 220 are brought into broader interfacial contact along the faying interface 222 of the copper workpieces 204, 206, which negates the sharp increase in the current density that previously existed prior to the collapse of the projections 207. At the time the projections 207 collapse, and while the current may still be flowing, the first and second faying surfaces 218, 220 interact in a way that will lead to the establishment of a metallurgical joint. Such interaction between the first and second faying surfaces 218, 220 may be in the form of solid-state particle softening and diffusion without melting either of the first and second copper workpieces 204, 206 or it may involve melting each of the first and second copper workpieces 204, 206 at their contacting faying surfaces 218, 220 such that the melted portions of the faying surfaces 218, 220 consume the faying interface 222 and comingle into a common pool that extends into each of the copper workpieces 204, 206.

Moving to Block 910 from Block 908, the passage of the electric current through the first and second copper workpieces 204, 206 is terminated and the first and second copper workpieces 204, 206 cool relatively quickly due to their high thermal conductivities. Upon cooling, a metallurgical joint 250 in the form of a solid-state joint or a fusion joint is established between the first and second copper workpieces 204, 206 across their faying interface 222 at the joining location 276 where the projections 207 were initially present and later collapsed. The metallurgical joints 250 are established because of the interaction that occurs between the first and second faying surfaces 218, 220 as a result of the concentration of heat within the projection 207 and the immediately surrounding portions of the faying surfaces 218, 220.

Moving to Block 912 from Block 910, the first and second spot welding electrodes 264, 268 are retracted. The now joined workpiece stack-up assembly 214 is removed from the spot welding apparatus 300 or reoriented relative to the weld gun at another location where welding is desired in the same way.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A method of resistance spot welding, comprising:
providing a first metal workpiece having a first faying surface and a first exterior surface opposite the first faying surface;
providing a second metal workpiece having a second faying surface and a second exterior surface opposite the second faying surface;
wherein one of first faying surface and the second faying surface includes a plurality of projections;
assembling the first metal workpiece in overlapping arrangement with the second metal workpiece such that the plurality of projections are in contact with the other of the first faying surface and the second faying surface;
applying a compression force against the first metal workpiece and the second metal workpiece to urge the first faying surface toward the second faying surface; and
passing an electrical current through the first metal workpiece and the second metal workpiece, wherein the electrical current is sufficient to generate and concentrate heat within the plurality of projections to collapse the plurality of projections to establish a metallurgical joint to join the first metal workpiece to the second metal workpiece.

2. The method of claim 1, wherein the compression force is applied by a pair of spot welding electrodes including a first electrode having a first electrode face in contact with the first exterior surface of the first metal workpiece and a second electrode having a second electrode face in contact with the second exterior surface of the second metal workpiece; and
wherein at least one of the first electrode face and the second electrode face includes a sufficient surface area in contact with the first exterior surface and the second exterior surface, respectively, to overlap an entirely of the plurality of projections.

3. The method of claim 2, wherein the first exterior surface is a planar first exterior surface and the second exterior surface is a planar second exterior surface.

4. The method of claim 3, wherein the first electrode face is a planar first electrode face and operable to apply a first force against the planar first exterior surface, and the second electrode face is a planar second electrode face and operable to apply a second force against the planar second exterior surface.

5. The method of claim 2, wherein each individual projection includes a surface contact area (SCA); and
wherein at least one of the first electrode face and the second electrode face includes an electrode surface area (ESA) about 1.5 to 5.0 times larger than a total of the surface contact areas (SCA_{Total}) of the plurality of projections.

6. The method of claim 5, wherein an individual projection includes a width of about 0.5 to 5.0 mm, a height of greater than 0.5 mm, and a length of 5 mm to 20 mm.

7. The method of claim 6, wherein the plurality of projections include at least one of a semi-sphere, a flat ring, a plurality of flat concentric rings, a raised rectangle, and a raised polygon having a trapezoid cross section.

8. The method of claim 1, wherein the first metal workpiece and the second metal workpiece are copper workpieces.

9. The method of claim 1, wherein one of the first metal workpiece and the second metal workpiece is a copper workpiece and the other of the first metal workpiece and the second metal workpiece is an aluminum workpiece.

10. The method of claim 1, wherein the first metal workpiece and the second metal workpiece are electrically conductive tabs for an electric vehicle.

11. A method of joining overlapping copper workpieces, comprising:
providing a first copper workpiece having a first faying surface and a first exterior surface opposite the first faying surface;
providing a second copper workpiece having a second faying surface defining a plurality of projections and a planar second exterior surface opposite the plurality of projections;
overlapping the first copper workpiece and the second copper workpiece such that the plurality of projections of the second faying surface are in contact with the first faying surface at a joining location where a metallurgical joint is ultimately established;
applying a compression force against the first exterior surface and the second exterior surface to urge the first faying surface and the second faying surface together; and
passing an electric current at the joining location through the first copper workpiece and the second copper workpiece, such that the electric current flows through the plurality of projections to generate sufficient heat to effectuate a collapsing of the plurality of projections to bring the first faying surface and the second faying surface into a broader interfacial contact to establish the metallurgical joint.

12. The method of claim 11, wherein the compression force is applied by a pair of spot welding electrodes includes a first spot welding electrode and a second spot welding electrode having a planar second electrode face; and
wherein the planar second electrode face is compressed against the planar second exterior surface of the second copper workpiece.

13. The method of claim 12, wherein the planar second electrode face includes a second electrode face surface area (ESA) sufficiently large to overlap an entirety of the plurality of projections at the joining location.

14. The method of claim 13, wherein the plurality of projections include a total surface contact area (SCA_{Total}); and
includes a ratio of ESA:SCA_{Total} of 1.5 to 5.0.

15. The method of claim 14, wherein the first faying surface of the first copper workpiece defines a plurality of first projections.

16. The method of claim 15, wherein the first exterior surface opposite the plurality of first projections is a planar first exterior surface; and
wherein the first spot welding electrode includes a planar first electrode face; and
wherein applying the compression force includes compressing the planar first electrode face against the planar first exterior surface of the first copper workpiece.

17. The method of claim 16, wherein at least one of the plurality of projections includes a height of at least 0.55 mm, a base width of 0.5 mm to 5.00 mm, and a length of 5 mm to 20 mm.

18. A method of resistance spot welding overlapping copper workpieces, comprising:
providing a first copper workpiece having a first faying surface defining a plurality of first projections and a planar first exterior surface opposite the plurality of first projections;
providing a second copper workpiece having a second faying surface defining a plurality of second projections and a planar second exterior surface opposite the plurality of second projections;
overlapping the first copper workpiece and the second copper workpiece such that the plurality of first projections of the first faying surface confronts the second faying surface and the plurality of second projections of the second faying surface confronts the first faying surface;
applying a first force against the planar first exterior surface by a planar first electrode face and applying a second force against the planar second exterior surface by a planar second electrode face, thereby urging the first faying surface and the second faying surface together; and
passing an electric current through the first copper workpiece and the second copper workpieces, such that the electric current flows through the plurality of first and second projections to generate sufficient heat to effectuate a collapsing of the plurality of first and second projections to bring the first faying surface and the second faying surface into a broader interfacial contact to establish a metallurgical joint.

19. The method of claim 18, wherein the plurality of first projections includes a total first projection surface contact area; and
wherein the first electrode face includes a first electrode surface area 0.5 to 1.5 times greater than the total first projection surface contact area.

20. The method of claim 19, where an individual projection includes a trapezoidal cross-sectional area having a height of greater than 0.55 mm, a base width of 0.5 mm to 5.00 mm, and a length of 5 mm to 20 mm.
